(19) United States
(12) Patent Application Publication
(10) Pub. No.: US 2013/0245789 A1
(43) Pub. Date: Sep. 19, 2013

(54) ELECTRIC TOOL AND DATA TRANSMISSION METHOD

(71) Applicant: HITACHI KOKI CO., LTD., Tokyo (JP)

(72) Inventors: Yoshio Iimura, Ibaraki (JP); Hironori Mashiko, Ibaraki (JP); Tomomasa Nishikawa, Ibaraki (JP); Tatsuya Ito, Ibaraki (JP)

(73) Assignee: HITACHI KOKI CO., LTD., Tokyo (JP)

(21) Appl. No.: 13/760,562

(22) Filed: Feb. 6, 2013

(30) Foreign Application Priority Data
Mar. 14, 2012 (JP) 2012-057290

(51) Int. Cl. G05B 11/01

(52) U.S. Cl. CPC G05B 11/01
USPC 700/12

(57) ABSTRACT

An electric tool includes a motor, a light having a function in addition to a data transmission, a switch configured to switch power supply to the light in accordance with a user operation; and a control unit. Upon a switch is switched from OFF to ON, the light is blinked at a frequency above the human-sensible range on the basis of data such as the usage history data of the electric tool. An average of the blinking frequency of the light is approximately 4,800 Hz when a bit rate is set to 9,600 bps, for example. Further, an average of a duty ratio of a drive signal of the light during blinking is approximately 50%.

This application claims priority from Japanese Patent Application No. 2012-057290 filed on Mar. 14, 2012, the entire subject-matter of which is incorporated herein by reference.

### TECHNICAL FIELD

The present invention relates to an electric tool capable of transmitting data such as usage history data to an outside and a data transmission method by the electric tool.

### BACKGROUND

Usage history data of an electric tool refers to a data indicating actual usage history of the electric tool until now after production of the electric tool. For example, the usage history data of the electric tool includes data such as the date and time of performing the screw fastening, the number of screw to be fastened, intensity (e.g., current value and applied time) of load at the time of the screw fastening, the time required for fastening one screw, or setting conditions at the time of the screw fastening. By collecting the usage history data, it is possible to confirm the usage frequency of the electric tool, to determine the cause of malfunction or to evaluate the validity of target quality to be set. Accordingly, by making use of the usage history data as a reference for the following product development, it is possible to improve the quality of the electric tool and. JP-A-2010-12587 discloses a technology in which the fastening data is stored in a portable memory card by a micro-computer every time when the fastening operation is performed.

### SUMMARY

In order to provide a function to transmit data such as the usage history data to the outside, a dedicated hardware is mounted on the electric tool. However, this causes increase in the size of the electric tool, increase in the number of parts and a cost-up.

Therefore, illustrative aspects of the present invention provide an electric tool which does not need to be equipped with a dedicated hardware for transmitting data such as the usage history data to an outside and a data transmission method by the electric tool.

According to one illustrative aspect of the invention, there is provided an electric tool comprising: a motor; a light having a function in addition to a data transmission; a switch configured to switch power supply to the light in accordance with a user operation; and a control unit configured to control the light, wherein the control unit controls the light to be blinked at a frequency above a human-sensible range on the basis of predetermined data when the switch is switched to ON or OFF.

According to another illustrative aspect of the invention, there is provided a method for transmitting usage history data of an electric tool from the electric tool to a data reader, the method comprising: turning on or off a switch, the switch being configured to switch power supply to a motor of the electric tool in accordance with a user operation; controlling a light of the electric tool to be blinked at a frequency above a human-sensible range on the basis of the usage history data when the switch is switched to ON or OFF, the light having a function in addition to a data transmission; and controlling the data reader to read out the usage history data by receiving the blinking light of the light using a light receiving element of the data reader.

Further, any combinations of the above components and a modification in the method or system of the present invention are also effective as an embodiment of the present invention.

According to the present invention, a light having a function in addition to a data transmission function is blinked on the basis of predetermined data by turning on or off a switch that is configured to switch power supply to the motor in accordance with a user operation, so that the predetermined data can be transmitted to the outside. Accordingly, it is possible to realize an electric tool which does not need to be equipped with a dedicated hardware for transmitting data such as the usage history data to the outside and a data transmission method by the electric tool. Further, since the blinking of the light is performed at a frequency above a human-sensible range, the present invention can suppress a feeling of strangeness to the user at the time of data transmission.

### BRIEF DESCRIPTION OF THE DRAWINGS

FIG. 1 is a schematic external view showing an electric tool according to an exemplary embodiment of the present invention in a state of facing a data reader;

FIG. 2 is a block diagram of the electric tool and the data reader;

FIGS. 3A to 3H are time charts showing ON/OFF of a trigger switch and a waveform of a drive signal for a lighting LED in accordance with the ON/OFF of the trigger switch; and

FIGS. 4A and 4B are format explanatory views of signal used in a data transmission.

### DETAILED DESCRIPTION OF THE PREFERRED EMBODIMENTS

Hereinafter, exemplary embodiments of the present invention will be described with reference to the accompanying drawings. The same or similar reference numerals are applied to the same or similar parts and elements throughout the drawings, and the duplicated description thereof will be omitted. Further, the embodiment is illustrative and not intended to limit the present invention. It should be noted that all the features and their combinations described in the embodiment are not necessarily considered as an essential part of the present invention.

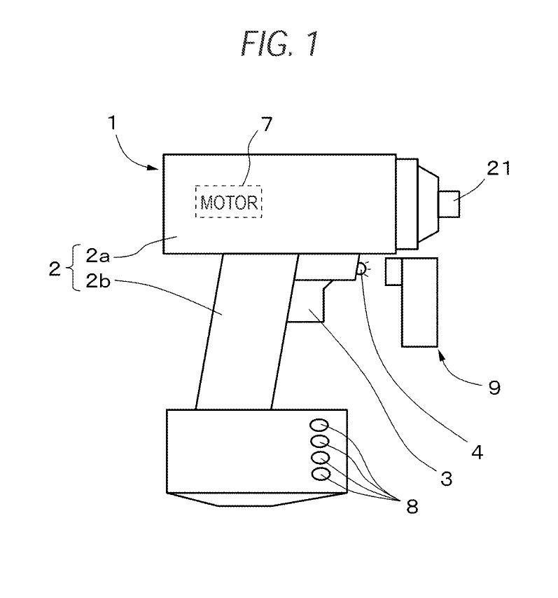

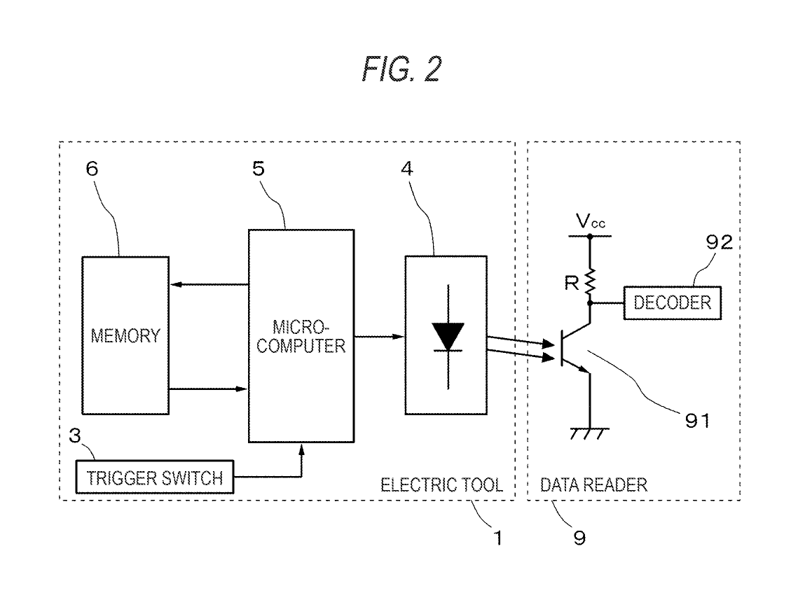

FIG. 1 is a schematic external view showing an electric tool 1 according to an exemplary embodiment of the present invention in a state of facing a data reader 9. FIG. 2 is a block diagram of the electric tool 1 and the data reader 9. In these figures, components of the electric tool 1 having no relation with data transmission are omitted.

As shown in FIG. 1, the electric tool 1 includes a motor 7 accommodated in a cylindrical body part 2a of a housing 2. When using the electric tool 1, the motor 7 is rotationally driven by pulling a trigger switch 3 provided at a handle part 2b of the housing 2 to supply power from a power source to the motor 7, the rotation of the motor 7 is transmitted to a tip of the electric tool via a deceleration mechanism (not shown) or the like and thus a tip tool (for example, a driver bit or a bolt fastening bit) (not shown) mounted to a leading end socket 21 of the body part 2a is rotationally driven. In this way, an operation such as screw fastening or bolt fastening is performed. The power source may be a battery or an AC power source such as a commercial power source. Incidentally, configuration and operation of the electric tool 1 relating to the screw fastening or the like are already known and thus a detailed description thereof will be omitted.

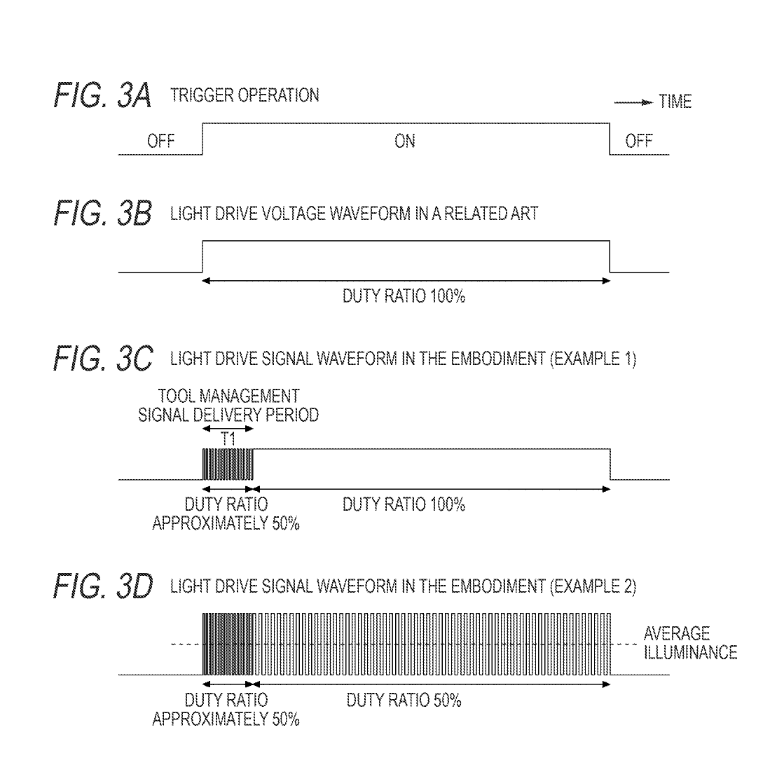

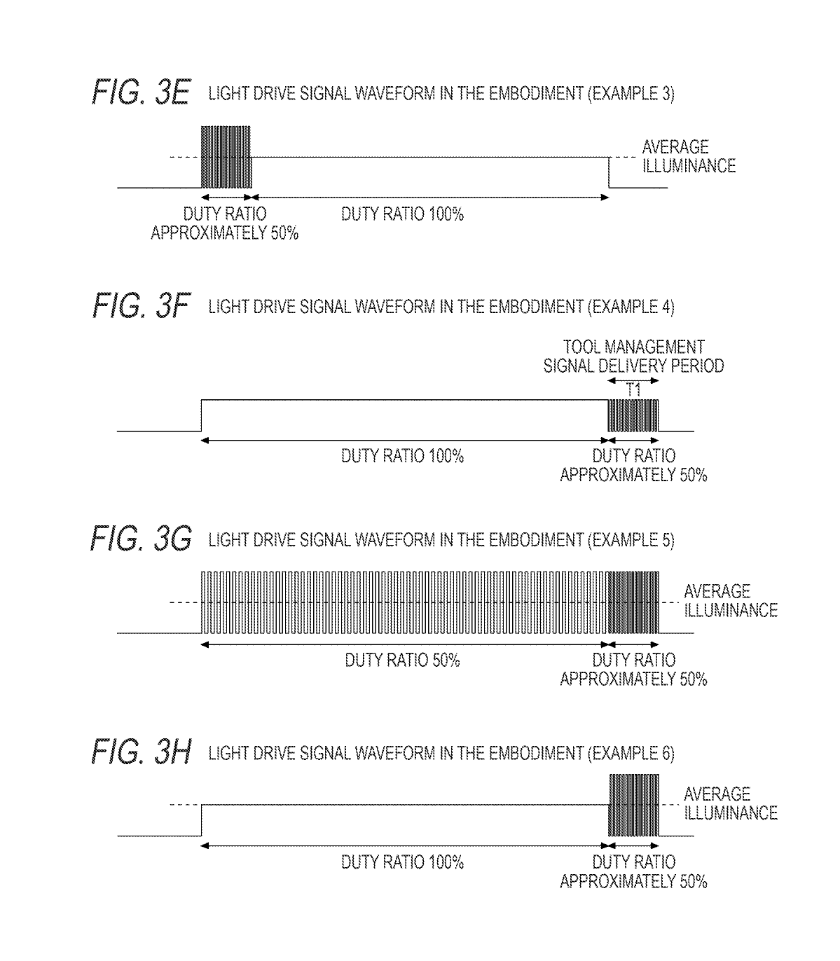

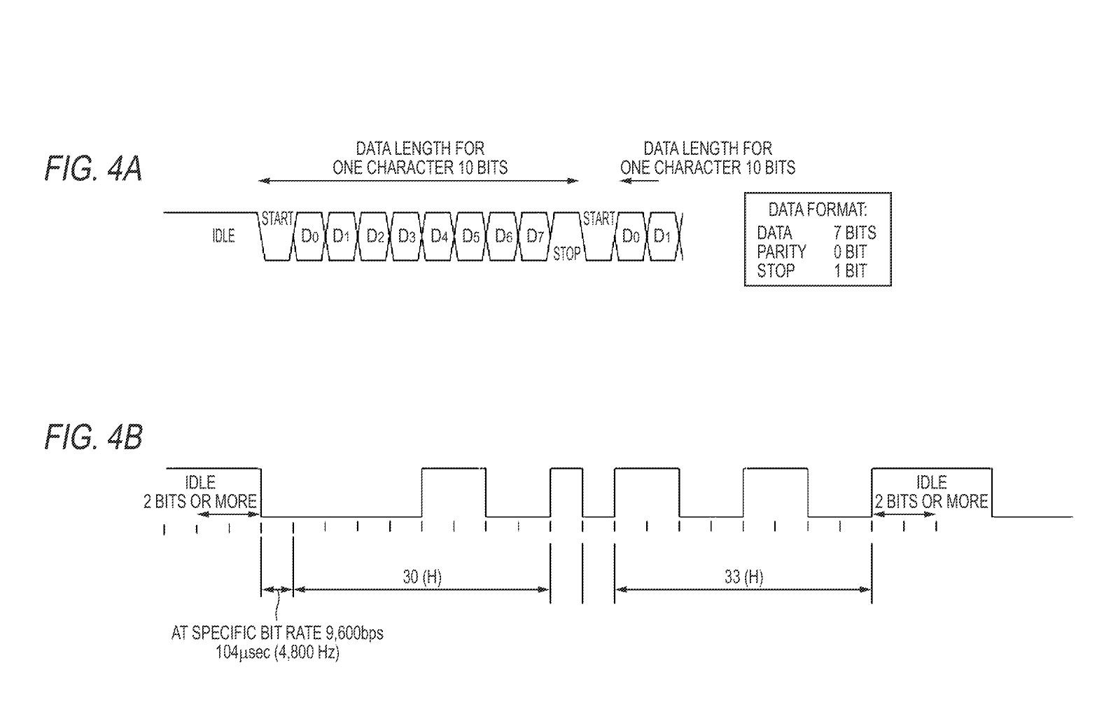

The electric tool 1 includes a lighting LED 4 as a light. The lighting LED 4 is located above the handle part 2b, for example, above the trigger switch 3. Upon the trigger switch 3 is turned on, the lighting LED 4 is turned on and irradiates the tip tool or an object to be screwed. In the present embodiment, the lighting LED 4 is blinked at a frequency above a human-sensible range on the basis of data such as the usage history data, so that the data can be transmitted to an outside from the electric tool 1. When transmitting the data, the lighting LED 4 is in a state of facing a light receiving part of the data reader 9, as shown in FIG. 1. The frequency above the human-sensible range is more than about 80 Hz. For example, when the frequency is set more than 1 kbps, preferably more than several tens of kbps (more than the bit rate to provide a blinking frequency of several tens of kHz) in a bit rate, the lighting LED can be blinked at the frequency above the human-sensible ranue, even taking into account variation due to the data. The blinking time of the lighting LED 4 and the amplitude of the applied voltage during blinking will be described later with referring to FIGS. 3A to 3H. The format used in the data transmission may be a conventional format. For example, a universal format shown in FIGS. 4A and 4B may be used. Here, FIG. 4A shows an example of asynchronous (start-stop synchronous) serial signal, and FIG. 4B shows an example of transmitting zero=30 (H) and 3=33 (H) in number of ASCII code. Since many micro-computers include UART (Universal Asynchronous Receiver Transmitter) circuit so as to support the universal format, it is advantageous to use the universal format shown in FIGS. 4A and 4B. Alternatively, a proprietary signal format may be used.

The electric tool 1 includes four status displaying LEDs 8, for example, in addition to the lighting LED 4. The status displaying LED 8 is configured to display a battery level (in a case of battery drive), a current condition setting, an operation mode, a setting torque or other information, for example.

As shown in FIG. 2, the electric tool 1 includes a micro-computer 5 as a control unit and a memory 6 configured to record the data such as the usage history data. Every time when a work such as the screw fastening is performed, the micro-computer 5 writes the usage history data in the memory 6. Further, when transmitting the data, the micro-computer 5 reads out the data such as the usage history data from the memory 6 and controls the lighting LED 4 to be blinked on the basis of the data (e.g., by a signal encoded by the data). The data transmission is performed upon a user turns on or off the trigger switch 3. That is, when the micro-computer 5 detects ON or OFF of the trigger switch 3, the micro-computer controls the lighting LED 4 to be blinked on the basis of the data. Optical signal (e.g., tool management signal) emitted by the blinking of the lighting LED 4 is received by a photo transistor 91 as a light receiving element (e.g., photoelectric conversion element) of the data reader 9. The photo transistor 91 and a resistance R are connected in series between a power source Vcc and ground. Light receiving signal (for example, ‘0’ when light is emitted from the lighting LED 4, and ‘1’ when light is not emitted from the lighting LED 4) whose level is migrated in synchronous with the blinking of the lighting LED 4 is emerged to a joint point of the photo transistor 91 and the resistance R. The light receiving signal is decoded by a decoder 92, and therefore the data such as the usage history data of the electric tool 1 is read by the data reader 9.

FIGS. 3A to 3H are time charts showing ON/OFF of the trigger switch 3 and a waveform of a drive signal (e.g., light drive signal) for the lighting LED 4 in accordance with the ON/OFF of the trigger switch. FIG. 3A shows ON/OFF of the trigger switch 3, FIG. 3B shows the drive signal of the lighting LED 4 in a related art, FIGS. 3C to 3H show the drive signal (examples 1 to 6) of the lighting LED 4 in the exemplary embodiment. As is apparent from FIG. 3B, in the related art, the lighting LED 4 is turned on simultaneously with ON of the trigger switch 3, and the lighting LED 4 is turned off simultaneously with OFF of the trigger switch 3 (signal transmission using the lighting LED 4 is not performed). In the present embodiment, as a signal transmitting method using the lighting LED 4, following six examples are illustrated. Incidentally, control of the drive signal of the lighting LED 4 is performed by the micro-computer 5.

### Example 1

### Method 1: FIG. 3C

In the present method, as shown in FIG. 3C, upon the trigger switch 3 is switched from OFF to ON (e.g., the trigger switch 3 is pulled out by a user), the lighting LED 4 is blinked at a frequency above the human-sensible range on the basis of data such as the usage history data of the electric tool 1. This state may be called as a turned-on state (e.g., blinking state for communication). Although a blinking frequency may be instantaneously varied to some extent by the data, an average of the blinking frequency is approximately 4,800 Hz when the bit rate is set to 9600 bps, for example. Further, a duty ratio of the drive signal of the lighting LED 4 during blinking may be instantaneously varied to some extent by the data, an average thereof is approximately 50%. After the blinking period (e.g., tool management signal delivery period T1) is finished (e.g., after the blinking on the basis of the data is finished), the micro-computer 5 controls the lighting LED 4 to be turned-on (e.g., controls the duty ratio of the drive signal of the lighting LED 4 to be substantially 100%) during the period when the trigger switch 3 is in an on-state and controls the lighting LED 4 to be turned off when the trigger switch 3 is switched to an off-state. The amplitudes of the drive signal of the lighting LED 4 in the blinking state and the turned-on state are equal to each other. Accordingly, the illuminance of the lighting LED 4 in the blinking state is about half of that in the turned-on state.

### Example 2

### Method 2: FIG. 3D

As shown in FIG. 3D, this method 2 is consistent with the method 1 except for: the amplitude of the drive signal of the lighting LED 4 in the blinking state (blinking state for communication) based on the data such as the usage history data is two times as that of the method 1; and in the period of the blinking state in the method 1 (e.g., after the blinking based on the data is finished and also when the trigger switch 3 is in the on-state), the lighting LED 4 is blinked (to be a blinking state for non-communication) at a frequency (e.g., different frequency) that is different from the frequency in the blinking state for communication and is above the human-sensible range. The frequency in the blinking state for non-communication may be lower than that in the blinking state for communication, and may be 2,000 Hz, for example. The duty ratio of the drive signal of the lighting LED 4 in the blinking state for non-communication is approximately 50%, and the magnitude thereof is the same as that in the blinking state for communication. In the present method, since the duty ratios of the drive signal of the lighting LED 4 in the blinking state for communication and the blinking state for non-communication are substantially equal to each other and the amplitudes thereof are also equal to each other, the illuminance of the lighting LED 4 in the blinking state for communication and the blinking state for non-communication is substantially consistent with each other. Accordingly, a feeling of strangeness to a user can be further suppressed, as compared to the method 1.

### Example 3

### Method 3: FIG. 3E

As shown in FIG. 3E, this method 2 is consistent with the method 1 except for that the amplitude of the drive signal of the lighting LED 4 in the blinking state is two times as that of the method 1. In the present method, since the amplitude of the drive signal of the lighting LED 4 in the turned-on state is about half of that in the blinking stated and the duty ratio of the drive signal of the lighting LED 4 in the turned-on state is about two times as that in the blinking state, the illuminance of the lighting LED 4 in the blinking state and the turned-on state is substantially consistent with each other. Accordingly, a feeling of strangeness to a user can be further suppressed, as compared to the method 1. Further, in the method 2, even during the blinking state for non-communication, the amplitude of the drive signal of the lighting LED 4 is large and the same as that in the blinking state for communication. Further, in the present method, the amplitude of the drive signal of the lighting LED 4 in the turned-on state is about half of that in the blinking stated. Accordingly, there are advantages that burden on the lighting LED may be reduced and the service life of the lighting LED 4 may become longer. These advantages are remarkable in a case where the amplitude of the drive signal of the lighting LED 4 exceeds rated voltage of the lighting LED 4 in the blinking state and is within the rated voltage in the turned-on state.

### Example 4

### Method 4: FIG. 3F

As shown in FIG. 3F, in the present method 4, upon the trigger switch 3 is switched from OFF to ON (that is, the trigger switch 3 is pulled out by a user), the lighting LED 4 is controlled to be the turned-on state. And then, upon the trigger switch 3 is switched from ON to OFF (that is, the trigger switch 3 is returned from the state pulled out by a user), the lighting LED 4 is blinked (controlled to be the blinking state) at a frequency above a human-sensible range on the basis of data such as the usage history data of the electric tool 1. The blinking frequency and the duty ratio of the drive signal of the lighting LED 4 at the time of blinking are the same as those in the method 1. After the blinking period (tool management signal delivery period T1) is finished (after the blinking is finished on the basis of the data), the micro-computer 5 controls the lighting LED 4 to be turned off when the trigger switch 3 is in an off-state. The amplitudes of the drive signal of the lighting LED 4 in the blinking state and the turned-on state are equal to each other. Accordingly, the illuminance of the lighting LED 4 in the blinking state is about half of that in the turned-on state.

### (Example 5

### Method 5: FIG. 3G

As shown in FIG. 3G, this method 5 is consistent with the method 4 except for: the amplitude of the drive signal of the lighting LED 4 in the blinking state (blinking state for communication) based on the data such as the usage history data is two times as that of the method 4; and in the period of the blinking state in the method 4 (e.g., period until the trigger switch 3 in an on-state is returned to an off-state), the lighting LED 4 is blinked (to be a blinking state for non-communication) at a frequency (e.g., different frequency) that is different from the frequency in the blinking state for communication and is above the human-sensible range. The frequency in the blinking state for non-communication may be lower than that in the blinking state for communication, and may be 2,000 Hz, for example. The duty ratio of the drive signal of the lighting LED 4 in the blinking state for non-communication is approximately 50% and the magnitude thereof is the same as that in the blinking state for communication. In the present method, since the duty ratios of the drive signal of the lighting LED 4 in the blinking state for communication and the blinking state for non-communication are substantially equal to each other and the amplitudes thereof are also equal to each other, the illuminance of the lighting LED 4 in the blinking state for communication and the blinking state for non-communication is substantially consistent with each other. Accordingly, a feeling of strangeness to a user can be further suppressed, as compared to the method 4.

### Example 6

### Method 6: FIG. 3H

As shown in FIG. 3H, this method 6 is consistent with the method 4 except for that the amplitude of the drive signal of the lighting LED 4 in the blinking state is two times as that of the method 4. In the present method, since the amplitude of the drive signal of the lighting LED 4 in the turned-on state is about half of that in the blinking stated and the duty ratio of the drive signal of the lighting LED 4 in the turned-on state is about two times as that in the blinking state, the illuminance of the lighting LED 4 in the blinking state and the turned-on state is substantially consistent with each other. Accordingly, a feeling of strangeness to a user can be further suppressed, as compared to the method 4. Further, similar to the method 3, there is an advantage that the service life of the lighting LED 4 becomes longer.

According to the present embodiment, following effects may be obtained.

(1) Since the data such as the usage history data can be transmitted to the outside by the blinking of the lighting LED 4 of the electric tool 1, it is not necessary to mount a dedicated hardware for the data transmission. Accordingly, it is possible to secure the data transmission function while eliminating problems such as increase in the size of the electric tool 1, increase in the number of parts and a cost-up. That is, the data transmission function of the electric tool 1 can be realized at a low cost and a small size, as compared to a case where a dedicated hardware is mounted.

(2) Since the data such as the usage history data can be transmitted to the outside by a normal ON/OFF operation of the trigger switch 3 to control power supply to the motor 7, there is a merit that a dedicated button or a special operation for the data transmission is not necessary.

(3) Since the lighting LED 4 is blinked on the basis of the data even during a normal screw fastening operation but the blinking is performed at a frequency above the human-sensible range, a feeling of strangeness to a user may be reduced, or may be suppressed to substantially zero.

(4) When there is a spare port or memory capacity in the micro-computer 5, it is also possible to provide the data transmission function to an electric tool having no the data transmission function by changing a software of the micro-computer 5 at a later time.

While description has been made in connection with particular embodiments of the present invention, it will be obvious to those skilled in the art that various changes and modification may be made therein without departing from the present invention. A modification thereof will be described.

The electric tool 1 is not limited to a pistol type, but may be of other types.

The light used in the data transmission is not limited to the lighting LED 4, but may be the status displaying LED 8.

The light LED 4 can be turned on by a first half pulling of the trigger switch 3 and power supply to the motor 7 can be activated by a second half pulling of the trigger switch 3. In this instance, it is possible to transmit the data such as the usage history data in such a way that the pulling of the trigger switch 3 is stopped at the first half pulling and therefore the power supply to the motor 7 is not accompanied.

It is also possible to transmit the data such as the usage history data by providing a switch for light which can be used to switch ON/OFF of the lighting LED 4 separately from the trigger switch 3 and operating ON or OFF of the switch for light.

What is claimed is:

1. An electric tool comprising:
a motor;
a light having a function in addition to a data transmission;
a switch configured to switch power supply to the light in accordance with a user operation; and
a control unit configured to control the light,
wherein the control unit controls the light to be blinked at a frequency above a human-sensible range on the basis of predetermined data when the switch is switched to ON or OFF.

2. The electric tool according to claim 1,
wherein the control unit controls the light to be blinked when the switch is switched to an on-state and then controls the light to be turned-on during a period when the switch is in the on-state.

3. The electric tool according to claim 1,
wherein the control unit controls the light to be switched from a turned-on state to a blinking state when the switch is switched to an off-state and then controls the light to be turned-off during a period when the switch is in the off-state.

4. The electric tool according to claim 2,
wherein the control unit controls the light to be turned on at a voltage lower than a magnitude of voltage applied to the light when the light is in the blinking state.

5. The electric tool according to claim 4,
wherein the magnitude of voltage applied to the light when the light is in the turned-on state is about half of the magnitude of voltage applied to the light when the light is in the blinking state.

6. The electric tool according to claim 3,
wherein the control unit controls the light to be turned on at a voltage lower than a magnitude of voltage applied to the light when the light is in the blinking state.

7. The electric tool according to claim 6,
wherein the magnitude of voltage applied to the light when the light is in the turned-on state is about half of the magnitude of voltage applied to the light when the light is in the blinking state.

8. The electric tool according to claim 1,
wherein the control unit controls the light to be blinked when the switch is switched to an on-state and then controls the light to be blinked at different frequency that is above the human-sensible range and is different from the frequency at the blinking state.

9. The electric tool according to claim 1, wherein:
the control unit controls the light to be switched to the blinking state when the switch is switched to an off-state and then controls the light to be turned-off during the period when the switch is in the off-state; and
the control unit controls the light, before being switched to the blinking state, to be blinked at different frequency that is above the human-sensible range and is different from the frequency at the blinking state.

10. The electric tool according to claim 8,
wherein a duty ratio of voltage applied to the light when the light is blinked at the different frequency is approximately 50%.

11. The electric tool according to claim 9,
wherein a duty ratio of voltage applied to the light when the light is blinked at the different frequency is approximately 50%.

12. The electric tool according to claim 1,
wherein the control unit controls the light to be blinked at a bit rate more than 1 kbps in the blinking state.

13. The electric tool according to claim 1,
wherein the predetermined data includes usage history data of the electric tool.

14. The electric tool according to claim 1,
wherein the light is a light for illumination.

15. The electric tool according to claim 1,
wherein the switch is configured to further serve as a switch for switching power supply to the motor in accordance with a user operation.

16. A method for transmitting usage history data of an electric tool from the electric tool to a data reader, the method comprising:
turning on or off a switch, the switch being configured to switch power supply to a motor of the electric tool in accordance with a user operation;
controlling a light of the electric tool to be blinked at a frequency above a human-sensible range on the basis of the usage history data when the switch is switched to ON or OFF, the light having a function in addition to a data transmission; and
controlling the data reader to read out the usage history data by receiving the blinking light of the light using a light receiving element of the data reader.
